(19) United States
(12) Patent Application Publication
(10) Pub. No.: US 2025/0293264 A1
(43) Pub. Date: Sep. 18, 2025

(54) NEGATIVE ELECTRODE, SOLID STATE BATTERY AND MANUFACTURING METHOD OF LAMINATE

(71) Applicant: HONDA MOTOR CO., LTD., Tokyo (JP)

(72) Inventors: Kiyoshi TANAAMI, Saitama (JP); Hiroshi SAKAI, Saitama (JP); Toshimitsu TANAKA, Saitama (JP)

(21) Appl. No.: 19/061,268

(22) Filed: Feb. 24, 2025

(30) Foreign Application Priority Data
Mar. 18, 2024 (JP) 2024-041990

(51) Int. Cl. H01M 4/80; H01M 4/02; H01M 4/04; H01M 4/38; H01M 4/66; H01M 10/0562

(52) U.S. Cl. CPC H01M 4/80; H01M 4/0404; H01M 4/043; H01M 4/386; H01M 4/661; H01M 10/0562; H01M 2004/021; H01M 2004/027

(57) ABSTRACT

A negative electrode of a solid state battery includes: a negative electrode mixture layer formed by filling pores of a metal porous body with a negative electrode mixture containing a negative electrode active material; and a void layer including a portion containing a solid electrolyte and a portion having voids in the pores of the metal porous body on a solid electrolyte layer side in a thickness direction of the metal porous body pressurized in the thickness direction, wherein a specific surface area of the metal porous body before the pressurization is 500 m²/m³ or more and 6000 m²/m³ or less.

### BACKGROUND

### Technical Field

The present invention relates to a negative electrode, a solid state battery, and a manufacturing method of a laminate.

### Related Art

Recentry, research and development on a secondary battery that contributes to improvement in energy efficiency have been conducted in order for more people to be able to access affordable, reliable, sustainable, and advanced energy. A solid state battery has a high energy density, and is used in a wide range of applications. In particular, a lithium ion secondary battery is becoming increasingly important as a power source for an electric vehicle (EV), a hybrid electric vehicle (HEVs), or the like.

As a configuration of the solid state battery, there is a known configuration in which a current collector constituting a negative electrode is made of foam metal in order to increase a filling density of an electrode active material. In this regard, JP 2022-108360 A discloses a solid state battery in which pores of a metal porous body as a current collector are filled with a negative electrode mixture in order to increase the amount of an active material per unit area of an electrode. The electrode in JP 2022-108360 A makes it possible to follow a volume change during charging and discharging by using an elastic force of the metal porous body.

### CITATION LIST

### Patent Literature

Patent Literature 1: JP 2022-108360 A

### SUMMARY

In order to contribute to further improvement in energy efficiency, the solid state battery is also demanded to be capable of maintaining a battery life also when charging and discharging are repeated. As demanded characteristics for this purpose, for example, when charging and discharging of the solid state battery are repeated, lithium ions, sodium ions, and the like are controlled to receive electrons in a negative electrode, and metallic lithium, metallic sodium, and the like are controlled to be deposited on the negative electrode. When metallic lithium or the like is deposited on the negative electrode, a gap is easily formed between layers. As a result, resistance of the solid state battery may increase, and internal short circuit in which a positive electrode and the negative electrode are electrically in contact with each other may also occur. In particular, in a high-capacity negative electrode, metallic lithium or the like is likely to be deposited.

Under such a background, an object of the present invention is to provide a negative electrode in which an influence of deposition of metallic lithium or the like, such as internal short circuit, is less likely to occur when the negative electrode is used in a solid state battery. This ultimately contributes to improvement in energy efficiency.

In order to achieve the above object, a negative electrode according to claim 1 of the present invention is a negative electrode of a solid state battery, the negative electrode including: a negative electrode mixture layer formed by filling pores of a metal porous body with a negative electrode mixture containing a negative electrode active material; and a void layer including a portion containing a solid electrolyte and a portion having voids in the pores of the metal porous body on a solid electrolyte layer side in a thickness direction of the metal porous body pressurized in the thickness direction, wherein a specific surface area of the metal porous body before the pressurization is 500 m²/m³ or more and 6000 m²/m³ or less.

According to this configuration, when metallic lithium or the like is deposited on the negative electrode, metallic lithium or the like is likely to be deposited in a concentrated manner in the pores of the metal porous body which are voids in the void layer, and deposition of metallic lithium or the like on a negative electrode interface or the like is suppressed. Therefore, when the negative electrode is used in a solid state battery, an influence of deposition of metallic lithium or the like, such as internal short circuit, can be less likely to occur.

An invention according to claim 2 of the present invention is the negative electrode according to claim 1, wherein in the void layer, the solid electrolyte has a density of 1.5 g/cc or more and less than 1.8 g/cc.

According to this configuration, it is possible to achieve both suppression of generation of cracks in a solid state battery manufacturing process and suppression of deterioration of ion conductivity.

An invention according to claim 3 of the present invention is the negative electrode according to claim 1, wherein in the void layer, a ratio of a volume occupied by the voids in the pores to a volume in the pores of the metal porous body is 10% or less.

According to this configuration, as compared with a case where the ratio of the volume occupied by the voids in the pores to the volume in the pores of the metal porous body is larger than 10%, a decrease in density of the negative electrode is suppressed, and therefore a decrease in energy density due to presence of the void layer in the negative electrode can be suppressed.

An invention according to claim 4 of the present invention is the negative electrode according to claim 1, wherein the negative electrode active material contains at least a silicon-based material.

According to this configuration, a negative electrode containing a silicon-based material in the negative electrode active material can be suitably used.

An invention according to claim 5 of the present invention is the negative electrode according to claim 4, wherein the negative electrode active material in the negative electrode mixture layer has a basis weight of more than 3 mg/cm².

According to this configuration, as compared with a case where the basis weight of the negative electrode active material in the negative electrode mixture layer is 3 mg/cm² or less, it is possible to suppress a decrease in capacity of the solid state battery due to charging and discharging while improving the capacity of the solid state battery.

An invention according to claim 6 of the present invention is the negative electrode according to claim 4, wherein a ratio of a discharge capacity of lithium that can enter the voids of the void layer due to charging and discharging to a discharge capacity of the negative electrode active material is 5% or more and 8% or less.

According to this configuration, it is possible to achieve both ensuring of a void for accommodating metallic lithium and the like deposited due to charging and discharging and suppression of a decrease in energy density.

A solid state battery according to claim 7 of the present invention includes the negative electrode according to any one of claims 1 to 6, a positive electrode containing lithium, and a solid electrolyte layer.

In this solid state battery, when metallic lithium or the like is deposited on the negative electrode, metallic lithium or the like is likely to be deposited in a concentrated manner in the pores of the metal porous body which are voids in the void layer, and deposition of metallic lithium or the like on a negative electrode interface or the like is suppressed. Therefore, an influence of deposition of metallic lithium or the like, such as internal short circuit, can be less likely to occur.

A manufacturing method of a laminate according to claim 8 of the present invention is a method for manufacturing a laminate including a solid electrolyte layer and a negative electrode, the method including: a step of applying a negative electrode mixture containing a negative electrode active material to a metal porous body to form a negative electrode mixture layer in which pores of the metal porous body are filled with the negative electrode mixture; a step of pressing an uneven portion of a pressurizing device against a surface of the metal porous body in which the negative electrode mixture layer is formed to form an uneven portion on the surface; and a step of applying a solid electrolyte to a surface of the metal porous body on which the uneven portion is formed to form a void layer having a portion containing the solid electrolyte and a portion having voids in the pores of the metal porous body, and the solid electrolyte layer.

In a solid state battery including a laminate manufactured by this manufacturing method, when metallic lithium or the like is deposited on the negative electrode, metallic lithium or the like is likely to be deposited in a concentrated manner in the pores of the metal porous body which are voids in the void layer, and deposition of metallic lithium or the like on a negative electrode interface or the like is suppressed. Therefore, when the negative electrode is used in a solid state battery, an influence of deposition of metallic lithium or the like, such as internal short circuit, can be less likely to occur.

### BRIEF DESCRIPTION OF DRAWINGS

FIG. 1 is a cross-sectional view schematically illustrating a laminate in a secondary battery;

FIG. 2 is a diagram illustrating a Cole-Cole plot created from measurement values;

FIG. 3 is a diagram illustrating a relationship between a porosity of a void layer and an energy density;

FIG. 4A is a diagram for explaining a filling step, and FIG. 4B is a diagram schematically illustrating a metal porous body dried after being filled with a negative electrode mixture;

FIG. 5 is a diagram for explaining an unevenness forming step;

FIG. 6 is a diagram illustrating a capacity of a coin type cell for each cycle in each of Example 1 and Comparative Examples 1 and 2; and

FIG. 7 is a diagram illustrating a capacity of a coin type cell for each cycle in each of Example 2 and Comparative Examples 3 and 4.

### DETAILED DESCRIPTION

Hereinafter, a preferred embodiment of the present invention will be described in detail.

### [Solid State Battery]

A solid state battery of the present embodiment includes a plurality of laminated unit cells formed by superimposing a positive electrode, a solid electrolyte layer, and a negative electrode. Note that the number of cells constituting the solid state battery may be one. It is known that the solid state battery has advantages such as having a low risk of ignition, being rapidly charged, being less likely to deteriorate, and having a long life. On the other hand, in the solid state battery, a short circuit phenomenon that occurs when metallic lithium or the like is deposited on the negative electrode is more likely to occur than in a secondary battery in which an electrolyte is a liquid.

In the solid state battery, the short circuit phenomenon that occurs when metallic lithium or the like is deposited on a negative electrode interface or the like is considered to occur because of the following reasons. In the solid state battery, the negative electrode and the solid state electrolyte layer form an interface between solid bodies. When metallic lithium is deposited, lithium ions are hardly conductive in the interface between the negative electrode and the solid electrolyte in the deposition place, thereby leading to a situation in which resistance also increases easily. As a result, cracks are easily generated in the electrode or the solid electrolyte layer, it is difficult to function as a cell, and the deposited metallic lithium enters a gap in the solid electrolyte layer, thereby easily causing the short circuit phenomenon.

On the other hand, in the negative electrode of the present embodiment, deposition of metallic lithium or the like on a negative electrode interface or the like is easily suppressed, and thus a battery life hardly decreases even in a solid state battery.

The solid state battery of the present embodiment may have any of a coin type, a button type, a cylindrical type, a square type, and a laminate type. In addition, the solid state battery of the present embodiment is applicable to a wide range of applications such as mobile devices including a mobile phone and a laptop computer, and in-vehicle applications.

### [Laminate]

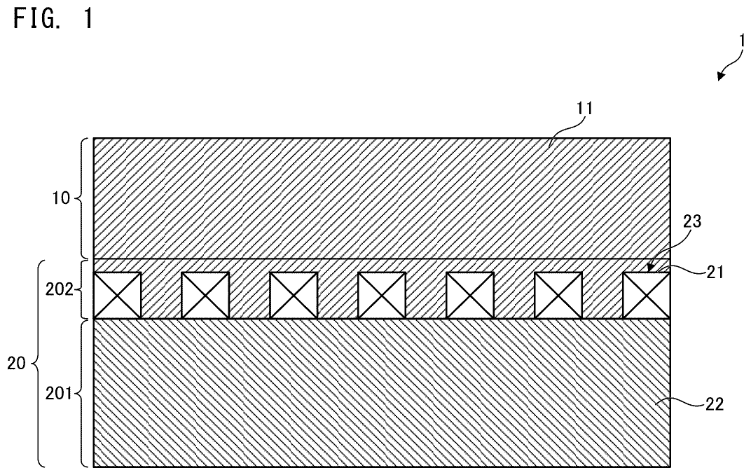

FIG. 1 is a cross-sectional view schematically illustrating a laminate 1 of the solid state battery. The laminate 1 includes a solid electrolyte layer 10 and a negative electrode 20. The solid electrolyte layer 10 is laminated on the negative electrode 20. Although not illustrated, in the solid state battery, a positive electrode (not illustrated) is laminated on the solid electrolyte layer 10.

### (Solid Electrolyte Layer)

The solid electrolyte layer 10 includes a solid electrolyte 11. In addition, the solid electrolyte 11 of the present embodiment is provided not only in the solid electrolyte layer 10 but also in pores of a metal porous body 21 of the negative electrode 20 described later. Examples of the solid electrolyte 11 include a sulfide-based solid electrolyte material, an oxide-based solid electrolyte material, a nitride-based solid electrolyte material, and a halide-based solid electrolyte material. Examples of the sulfide-based solid electrolyte material include an LPS-based halogen (Cl, Br, or I), Li₂S—P₂S₅, and Li₂S—P₂S₅—LiI. Note that the above description of “Li₂S—P₂S₅” means a sulfide-based solid electrolyte material obtained using a raw material composition containing Li₂S and P₂S₅, and the same applies to other descriptions. Examples of the oxide-based solid electrolyte material include a NASICON type oxide, a garnet type oxide, and a perovskite type oxide. Examples of the NASICON type oxide include an oxide containing Li, Al, Ti, P, and O (for example, Li_{1.5}A_{10.5}Ti_{1.5}(PO₄)₃). Examples of the garnet type oxide include an oxide containing Li, La, Zr, and O (for example, Li₂La₃Zr₂O₁₂). Examples of the perovskite type oxide include an oxide containing Li, La, Ti, and O (for example, LiLaTiO₃).

The solid electrolyte 11 preferably has a particle size of more than 0.5 μm and less than 5 μm. When the particle size of the solid electrolyte 11 is 0.5 μm or less, dispersion of the solid electrolyte 11 is likely to be insufficient when a slurry of the solid electrolyte 11 is prepared, and application of the slurry is difficult because it is difficult to adjust the viscosity of the slurry. When the particle size of the solid electrolyte 11 is 5 μm or more, unevenness is likely to occur in application of the solid electrolyte 11 to the metal porous body 21 because it is difficult to uniformly provide the solid electrolyte 11 in pores of the metal porous body 21. When unevenness occurs in application of the solid electrolyte 11 to the metal porous body 21, electric resistance is likely to increase.

The solid electrolyte layer 10 preferably includes 90 parts by mass or more and 97 parts by mass or less of the solid electrolyte 11 and 3 parts by mass or more and 10 parts by mass or less of a binder. The thickness of the solid electrolyte layer 10 is not particularly limited because various aspects are used depending on specifications of the cell, but is preferably, for example, 10 μm or more and 50 μm or less.

The electric resistance of solid electrolyte layer 10 is specified by impedance measurement. The electron conductivity of the solid electrolyte layer 10 is specified by measuring the electric resistivity of the solid electrolyte layer 10 or using a scanning probe microscope. Furthermore, the thickness and density of the solid electrolyte layer 10 are specified by using a scanning electron microscope (SEM) after CP processing.

### (Negative Electrode)

The negative electrode 20 includes the metal porous body 21 as a current collector and a negative electrode mixture 22.

The metal porous body 21 has pores continuous with each other. In the present embodiment, pores of the metal porous body 21 are filled with the negative electrode mixture 22. Examples of the metal porous body include a mesh, a woven fabric, a nonwoven fabric, an embossed body, a punched body, an expanded body, and a foamed body. Examples of a metal used for the metal porous body include nickel, aluminum, stainless steel, titanium, copper, and silver.

The current collector formed of the metal porous body has a large surface area. Therefore, by filling the current collector with a negative electrode mixture containing a negative electrode active material, it is possible to increase the amount of the active material per unit area of the electrode. Therefore, when the negative electrode of the present embodiment is used in a solid state battery, the solid state battery has a high energy density.

The negative electrode mixture 22 contains a negative electrode active material. The negative electrode active material is not particularly limited as long as it can occlude and release lithium ions, and examples thereof include a silicon-based material, a carbon-based material, and a metal-based material. The negative electrode 20 of the present embodiment is suitably used when the negative electrode active material contained in the negative electrode mixture 22 is a silicon-based material.

Here, in a case where the negative electrode active material is a silicon-based material, silicon easily expands and contracts when charging and discharging are repeated as a solid state battery. For this reason, the negative electrode active material tends to slip down from the current collector, an interface is unstable, and deposition of metallic lithium is easily accelerated. On the other hand, in the negative electrode 20 of the present embodiment, since the current collector is the metal porous body 21, the negative electrode active material hardly slips down.

Examples of the silicon-based material of the negative electrode active material include Si, Sio, and SiO₂. Examples of the carbon-based material include artificial graphite, natural graphite, hard carbon, and soft carbon. Examples of the metal-based material include metallic lithium, a lithium alloy, a metal oxide, a metal sulfide, and a metal nitride.

The negative electrode mixture 22 may contain the solid electrolyte 11, a binder, and a conductive aid.

The negative electrode mixture 22 preferably contains 65 parts by mass or more and 75 parts by mass or less of a negative electrode active material, 23 parts by mass or more and 33 parts by mass or less of the solid electrolyte 11, 1 part by mass of a binder, and 1 part by mass of a conductive aid.

The electric resistance, the electron conductivity, the thickness, and the density of the negative electrode mixture 22 are measured by the same method as the method for the solid electrolyte layer 10.

The negative electrode active material preferably has a particle size of more than 0.1 μm and less than 10 μm. When the particle size of the negative electrode active material is 0.1 μm or less, dispersion of the negative electrode active material is likely to be insufficient when a slurry of the negative electrode mixture 22 containing the negative electrode active material is prepared, and application of the slurry is difficult because it is difficult to adjust the viscosity of the slurry. When the particle size of the negative electrode active material is 1 μm or more, unevenness is likely to occur in filling application of the negative electrode mixture 22 to the metal porous body 21 because it is difficult to fill the pores of the metal porous body 21 with the negative electrode active material. In addition, when unevenness occurs in filling application of the negative electrode mixture 22 to the metal porous body 21, electric resistance is likely to increase.

The layer constituting the negative electrode 20 includes the negative electrode mixture layer 201 and the void layer 202.

The negative electrode mixture layer 201 is a layer formed by filling the pores of the metal porous body 21 with the negative electrode mixture 22. The negative electrode active material in the negative electrode mixture layer 201 preferably has a basis weight of more than 3 mg/cm². When the basis weight of the negative electrode active material in the negative electrode mixture layer 201 is more than 3 mg/cm², the capacity of the solid state battery can be improved. The thickness of the negative electrode mixture layer 201 is not particularly limited because various aspects are used depending on specifications of the cell, but is preferably, for example, 10 μm or more and 200 μm or less.

The void layer 202 is located on the negative electrode mixture layer 201 and includes the metal porous body 21 and the solid electrolyte 11. More specifically, the void layer 202 includes a portion where the solid electrolyte 11 is provided, and a void portion 23 in which at least a part of the inside of the pores of the metal porous body 21 is a void without including either of the solid electrolyte 11 and the negative electrode mixture 22. Therefore, the void layer 202 can also be regarded as a low density layer in which the density of the solid electrolyte 11 is lower than that of the solid electrolyte layer 10.

Note that although the metal porous body 21 is illustrated only in the void portion 23 of the void layer 202 in FIG. 1, the metal porous body 21 is also provided in a portion of the negative electrode mixture layer 201 filled with the negative electrode mixture 22 and a portion of the void layer 202 filled with the solid electrolyte 11.

The negative electrode 20 of the present embodiment includes the negative electrode mixture layer 201 and the void layer 202, and thus a solid state battery having a high energy density is obtained. In addition, when charging and discharging are repeated as a solid state battery, lithium ions and electrons present in the vicinity of the negative electrode 20 are likely to be transmitted to the void portion 23 along a metal skeleton of the metal porous body 21 and the solid electrolyte 11 in the void layer 202, and lithium ions are likely to be stably deposited as metallic lithium in the void of the void portion 23. In such a solid state battery, the deposition position of lithium can be controlled as compared with a conventional solid state battery in which metallic lithium is deposited at random positions in a negative electrode. Therefore, internal short circuit or the like that has been caused by deposition of metallic lithium in the conventional solid state battery is suppressed to obtain a solid state battery having high cycle characteristics. That is, in the present embodiment, the void layer 202 having the void portion 23 is provided in the negative electrode 20 in order to accommodate metallic lithium to be deposited due to charging and discharging.

In the example illustrated in FIG. 1, an upper portion in the void layer 202 is filled with the solid electrolyte 11 without including the void portion 23, but the present invention is not limited thereto. The void layer 202 may include the void portion 23 at any position in the vertical direction.

### (Positive Electrode)

The positive electrode includes a positive electrode mixture containing a positive electrode active material. The positive electrode active material is not particularly limited as long as it can occlude and release lithium ions, and examples thereof include LiCoO₂, Li(Ni_{5/10}CO_{2/10}Mn_{3/10})O₂, Li(N_{16/10}CO_{2/10}Mn_{2/10})O₂, Li(Ni_{8/10}CO_{1/10}Mn_{1/10})O₂, Li(Ni_{0.8}CO_{0.15}A_{10.05})O₂, Li(Ni_{1/6}CO_{4/6}Mn_{1/6})O₂, Li(Ni_{1/3}CO_{1/3}Mn_{1/3})O₂, LiCoO₄, LiMn₂O₄, LiNiO₂, LiFePO₄, and lithium sulfide.

### (Other Components)

The solid state battery may contain components other than the above-described materials. In addition, the other components are not particularly limited, and only need to be components that can be used when a solid state battery is prepared. Examples of the other components include a conductive aid and a binder. Examples of the conductive aid include acetylene black. Examples of a binder of the positive electrode include polyvinylidene fluoride. Examples of a binder of the negative electrode include sodium carboxymethylcellulose, a styrene butadiene rubber, and sodium polyacrylate.

### [Characteristics of Laminate]

Next, a characteristic configuration of the laminate 1 of the present embodiment will be described.

### (Specific Surface Area of Metal Porous Body)

The metal porous body 21 is controlled to have a specific surface area corresponding to a pressure applied when the metal porous body 21 is pressurized for forming the negative electrode 20 or forming a cell, but the specific surface area of the metal porous body 21 before the metal porous body 21 is pressurized is preferably 500 m²/m³ or more and 6000 m²/m³ or less. Note that the specific surface area of the metal porous body 21 is measured with a mercury porosimeter.

When the specific surface area of the metal porous body 21 before the metal porous body 21 is pressurized is larger than 6000 m²/m³, the strength of the metal porous body 21 is lowered, and cracks may be generated in the metal porous body 21 due to charging and discharging of the solid state battery. As a result, it may be difficult to ensure a function as the solid state battery.

In addition, when the specific surface area of the metal porous body 21 before the pressurization is less than 500 m²/m³, a contact area between the metal porous body 21 and the solid electrolyte 11 and a contact area between metal skeletons of the metal porous body 21 are small, it is difficult to form an electron transfer path (electronic path), and electric resistance tends to increase. Therefore, metallic lithium is less likely to be deposited during charging and discharging. In addition, diffusion resistance is likely to increase because the solid electrolyte 11 provided in the pores of the metal porous body 21 is likely to be unevenly distributed.

Table 1 is a table presenting a relationship between the specific surface area of the metal porous body 21 before the metal porous body 21 is pressurized and electric resistivity.

TABLE 1

| Specific surface | | | |
|---|---|---|---|
| area (m²/m³) | 100 | 500 | 6000 |
| Electric resistivity | 29.6 | 7.5 | 3.7 |
| (μΩ · cm) | | | |

Table 1 presents the electric resistivity of each of three metal porous bodies 21 having different specific surface areas before the metal porous bodies 21 are pressurized. As presented in Table 1, the metal porous body 21 having a specific surface area of 100 m²/m³ before the metal porous body 21 is pressurized has higher electric resistivity than the metal porous body 21 having a specific surface area of 500 m²/m³ before the metal porous body 21 is pressurized and the metal porous body 21 having a specific surface area of 6000 m²/m³ before the metal porous body 21 is pressurized.

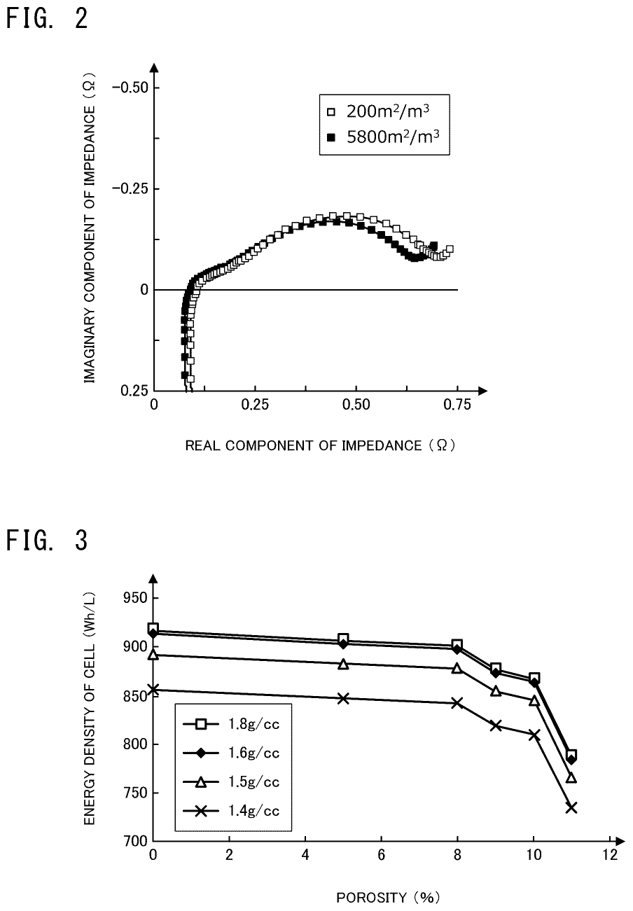

FIG. 2 is a diagram illustrating a Cole-Cole plot created from measurement values obtained by measuring an impedance of the solid state battery while changing a frequency of an AC voltage applied to the negative electrode 20. For the measurement, two solid state batteries: a solid state battery including the negative electrode 20 in which the specific surface area of the metal porous body 21 was 200 m²/m³ before the metal porous body 21 was pressurized, and a solid state battery including the negative electrode 20 in which the specific surface area of the metal porous body 21 was 5800 m²/m³ before the metal porous body 21 was pressurized were used. In FIG. 2, the horizontal axis represents a real component of the impedance, and the vertical axis represents an imaginary component of the impedance.

In the Cole-Cole plot illustrated in FIG. 2, a first intercept with the Y-axis is an estimated value of electric resistance, and an intercept of a drawn right semicircle with the Y-axis is an estimated value of diffusion resistance. As illustrated in FIG. 2, it was confirmed that both the electric resistance and the diffusion resistance of the solid state battery including the negative electrode 20 in which the specific surface area of the metal porous body 21 was 200 m²/m³ before the pressurization were higher than those of the solid state battery including the negative electrode 20 in which the specific surface area of the metal porous body 21 was 5800 m²/m³ before the pressurization.

### (Density of Solid Electrolyte in Void Layer)

In the void layer 202, the solid electrolyte 11 preferably has a density of 1.5 g/cc or more and less than 1.8 g/cc.

When the density of the solid electrolyte 11 in the void layer 202 is 1.8 g/cc or more, cracks may be generated in the void layer 202 when the negative electrode 20 is pressurized in a cell forming step. In addition, when the density of the solid electrolyte 11 in the void layer 202 is less than 1.5 g/cc, the energy density is reduced, and a contact area between particles of the solid electrolyte 11 in the void layer 202 is reduced. Therefore, ion conductivity is likely to be reduced. In this case, since ion diffusion resistance as a cell increases, deterioration of rate characteristics such as difficulty in rapid charging of the solid state battery may be caused.

Note that the density of the solid electrolyte 11 in the void layer 202 is controlled by a pressure applied when the negative electrode 20 and the solid electrolyte layer 10 are pressurized by a roll press in order to form the laminate 1.

A vertical cross section of the void layer 202 is prepared by irradiating the laminate 1 with an argon beam, and the thickness of the void layer 202 is measured by observing the prepared cross section of the void layer 202 with an electron microscope. Then, the density of the solid electrolyte 11 in the void layer 202 is calculated from the measured thickness of the void layer 202 and the weight per unit area of the solid electrolyte 11 in the void layer 202.

### (Porosity of Void Layer)

In the void layer 202, a ratio of the volume occupied by voids of the void portion 23 to the volume in pores of the metal porous body 21 is preferably 10% or less. Note that, in the void layer 202, the ratio of the volume occupied by the voids of the void portion 23 to the volume in the pores of the metal porous body 21 may be hereinafter referred to as a porosity of the void layer 202.

When the porosity of the void layer 202 is more than 10%, the density of the negative electrode 20 is reduced, and therefore the thickness of the negative electrode 20 necessary for ensuring the capacity of the solid state battery is increased. In addition, when the thickness of the negative electrode 20 increases, the number of cells constituting the solid state battery having a predetermined thickness decreases, whereby the energy density of the solid state battery may decrease. Furthermore, an initial capacity ratio (N/P ratio) between the positive electrode and the negative electrode 20 in the solid state battery easily deviates from a target value, whereby deterioration accompanied by a decrease in the capacity of the solid state battery easily proceeds.

Note that the porosity of the void layer 202 is controlled by a pressure applied when the negative electrode 20 and the solid electrolyte layer 10 are pressurized by a roll press in order to form the laminate 1.

In addition, the porosity of the void layer 202 is measured by a gas adsorption method.

FIG. 3 is a diagram illustrating a relationship between a porosity of the void layer 202 and an energy density. FIG. 3 illustrates the energy densities of four solid state batteries including the solid electrolytes 11 having different densities in the void layer 202. In addition, the energy density of each of the solid state batteries is illustrated for each porosity of the void layer 202.

As illustrated in FIG. 3, it was confirmed that when the density of the solid electrolyte 11 in the void layer 202 was 1.4 g/cc, the energy density of the solid state battery was lower than that when the density of the solid electrolyte 11 in the void layer 202 was 1.5 g/cc, 1.6 g/cc, or 1.8 g/cc.

In any of the solid batteries, it was confirmed that when the porosity of the void layer 202 was larger than 10%, reduction in the energy density of the solid state battery was significant.

### (Discharge Ratio of Lithium to Negative Electrode Active Material)

A ratio of a discharge capacity of lithium that can enter voids in the void portion 23 of the void layer 202 due to charging and discharging to a discharge capacity of the negative electrode active material in the negative electrode 20 is preferably 5% or more and 8% or less. Note that lithium that can enter voids in the void portion 23 of the void layer 202 due to charging and discharging means metallic lithium present in the void layer 202 when all voids formed in advance in the void portion 23 are filled with metallic lithium deposited due to charging and discharging. The ratio of a discharge capacity of lithium that can enter voids in the void portion 23 of the void layer 202 due to charging and discharging to a discharge capacity of the negative electrode active material in the negative electrode 20 may be hereinafter referred to as a discharge ratio of lithium to the negative electrode active material.

When the discharge ratio of lithium to the negative electrode active material is less than 5%, voids of the void portion 23 necessary for accommodating metallic lithium deposited due to charging and discharging may be insufficient. When the discharge ratio of lithium to the negative electrode active material is more than 88, the thickness of the negative electrode 20 necessary for ensuring the capacity of the solid state battery increases. In addition, when the thickness of the negative electrode 20 increases, the number of cells constituting the solid state battery having a predetermined thickness decreases, whereby the energy density of the solid state battery may decrease.

### [Method for Manufacturing Solid State Battery]

Next, a method for manufacturing the solid state battery will be described.

The solid state battery of the present embodiment is manufactured through a negative electrode manufacturing step of manufacturing the negative electrode 20, a laminate manufacturing step of manufacturing the laminate 1 by laminating the solid electrolyte layer 10 on the negative electrode 20, and a laminating step of laminating the positive electrode on the laminate 1. In addition, the negative electrode manufacturing step includes a filling step of filling pores of the metal porous body 21 with the negative electrode mixture 22 by application, and an unevenness forming step of forming unevenness in the metal porous body 21 filled with the negative electrode mixture 22.

### (Filling Step)

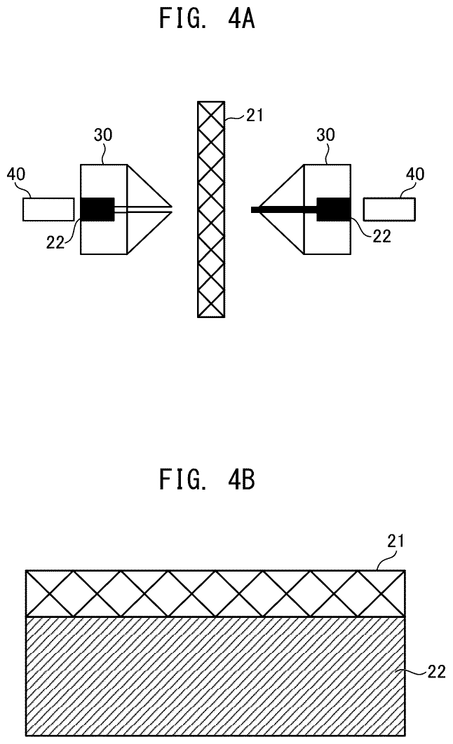

FIG. 4A is a diagram for explaining the filling step. FIG. 4B is a diagram schematically illustrating the metal porous body 21 dried after being filled with the negative electrode mixture 22 by application.

As illustrated in FIG. 4A, two coaters 30 and two plungers 40 are used for filling pores of the metal porous body 21 with the negative electrode mixture 22 by application. In the present embodiment, the plunger 40 extrudes the negative electrode mixture 22 filled in the coater 30 as a slurry, whereby the slurry is discharged from the coater 30. The coaters 30 are disposed on both outer sides of the metal porous body 21 in a thickness direction thereof, and discharge the slurry to both surfaces of the metal porous body 21 to fill pores of the metal porous body 21 with the slurry by application.

The coater 30 and the plunger 40 can move in a longitudinal direction of the metal porous body 21 (vertical direction in the illustrated example). The plunger 40 controls whether or not to discharge the slurry from the coater 30 by controlling a force for pushing the slurry filled in the coater 30 while moving together with the coater 30. In other words, the plunger 40 controls whether or not to fill pores of the metal porous body 21 with the slurry by application depending on the position of the metal porous body 21 in the longitudinal direction by controlling a force for pushing the slurry filled in the coater 30.

The pores of the metal porous body 21 are filled with the slurry by application, and then the metal porous body 21 is dried with the thickness direction oriented in the vertical direction. In this drying step, the slurry with which the pores of the metal porous body 21 are filled by application are accumulated on a lower side under gravity. Therefore, as illustrated in FIG. 4B, in the dried metal porous body 21, a layer in which pores are not filled with the negative electrode mixture 22 is formed on a layer in which pores are filled with the negative electrode mixture 22.

### (Unevenness Forming Step)

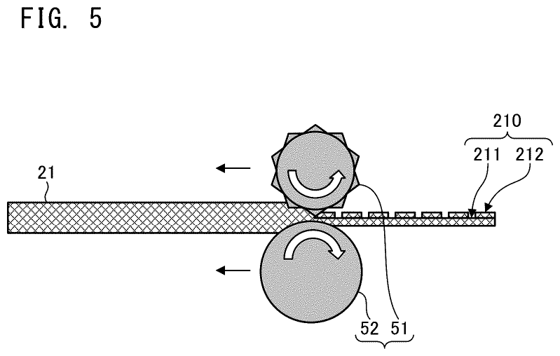

FIG. 5 is a diagram for explaining an unevenness forming step.

After the filling step described above, as illustrated in FIG. 5, the metal porous body 21 is pressurized by a roll press 50 which is a pressurizing device.

The roll press 50 includes an uneven roller 51 as an example of an uneven portion whose surface is formed in an uneven shape, and a perfect circle roller 52 whose surface is formed in a perfect circle shape. The uneven roller 51 and the perfect circle roller 52 are disposed on different surfaces of the metal porous body 21 in the thickness direction, and press the metal porous body 21 therebetween. More specifically, the uneven roller 51 presses a layer side in which the metal porous body 21 is not filled with the negative electrode mixture 22, and the perfect circle roller 52 presses a layer side in which the metal porous body 21 is filled with the negative electrode mixture 22. In addition, the specific surface area of the metal porous body 21 is controlled depending on a pressure applied to the metal porous body 21 by this pressing of the roll press 50.

In addition, the uneven roller 51 rotates in the counterclockwise direction in the drawing and the perfect circle roller 52 rotates in the clockwise direction in the drawing in a state where the uneven roller 51 and the perfect circle roller 52 press the metal porous body 21 therebetween, whereby the uneven roller 51 and the perfect circle roller 52 move along the longitudinal direction of the metal porous body 21. As a result, the metal porous body 21 is pressurized in the longitudinal direction, and an uneven portion 210 including a recessed portion 211 and a protruding portion 212 is formed on a surface portion of the metal porous body 21 on a side where the uneven roller 51 is pressed. The uneven portion 210 is formed of a portion of the metal porous body 21 where pores are not filled with the negative electrode mixture 22, illustrated in FIG. 4B. Therefore, the uneven portion 210 of the metal porous body 21 is a portion where pores are not filled with the negative electrode mixture 22.

### (Laminate Manufacturing Step)

Next, the solid electrolyte 11 is applied to the pressurized metal porous body 21. In the present embodiment, the solid electrolyte 11 is applied to a surface of the uneven portion 210 of the metal porous body 21. At this time, the solid electrolyte 11 enters the recessed portion 211 of the metal porous body 21, and the solid electrolyte 11 is laminated on a surface of the protruding portion 212. In addition, the solid electrolyte 11 is laminated in a layer shape not only on a surface of the uneven portion 210 but also above the uneven portion 210 and roll-pressed, whereby the negative electrode 20 including the negative electrode mixture layer 201 and the void layer 202 illustrated in FIG. 1 is formed, and the laminate 1 including the negative electrode 20 and the solid electrolyte layer 10 is formed. Here, the void portion 23 of the metal porous body 21 illustrated in FIG. 1 is a portion in a pore of the protruding portion 212 of the metal porous body 21 illustrated in FIG. 5.

Note that, as long as a void is formed in at least a part of the pore of the protruding portion 212 of the metal porous body 21, the solid electrolyte 11 may be included in a part of the pore of the protruding portion 212, or does not have to be included therein.

### (Lamination Step)

Next, the laminate in which the positive electrode is further laminated on the formed laminated body 1 is pressurized by uniaxial pressing to form one unit cell as a solid state battery.

### EXAMPLES

Next, Examples of the present invention will be described, but the present invention is not limited to Examples below.

### Example 1

### (Preparation of Coin Type Cell (Solid State Battery))

A slurry of a negative electrode mixture was prepared using 65 parts by mass of silicon as a negative electrode active material, 33 parts by mass of a solid electrolyte, 1 part by mass of a binder, and 1 part by mass of a conductive aid. Next, the obtained slurry was filled into pores of a metal porous body used as a current collector and having a specific surface area of 5800 m²/m³ by the method illustrated in FIG. 4A as a filling step, and the metal porous body was dried. Thereafter, the metal porous body was pressurized by the method illustrated in FIG. 5 as an unevenness forming step to form a negative electrode mixture layer containing the negative electrode active material having a basis weight of 5 mg/cm² and to form unevenness on a surface of the metal porous body.

Next, a slurry of the solid electrolyte was prepared using 90 parts by mass of the solid electrolyte and 10 parts by mass of the binder. The obtained slurry was applied to the surface of the metal porous body on which unevenness was formed, the metal porous body was dried, and then the metal porous body was pressurized by a roll press to prepare the laminate illustrated in FIG. 1.

Furthermore, a slurry of a positive electrode mixture made of lithium was prepared. The obtained slurry was applied to the laminate, and the laminate was dried. Thereafter, uniaxial pressing of pressurizing the laminate with a pressure of 3 MPa was performed to prepare a coin type cell having a diameter of 10 mm.

### Example 2

A coin type cell of Example 2 was prepared in a similar manner to Example 1 except that the basis weight of the negative electrode active material in the negative electrode mixture layer was set to 10 mg/cm².

### Comparative Example 1

A coin type cell of Comparative Example 1 in which the basis weight of the negative electrode active material in the negative electrode mixture layer was 5 mg/cm² and the diameter was 10 mm was prepared by the same method as in Example 1 except that a copper foil was used as a current collector, a negative electrode mixture was loaded on the copper foil, and the copper foil was pressurized using a roll press without unevenness. In the negative electrode of the coin type cell of Comparative Example 1, a metal porous body was not used, and a void layer as illustrated in FIG. 1 was not formed.

### Comparative Example 2

A coin type cell of Comparative Example 2 in which the basis weight of the negative electrode active material in the negative electrode mixture layer was 5 mg/cm² and the diameter was 10 mm was prepared by the same method as in Example 1 except that a negative electrode was prepared by pressurizing, using a roll press without unevenness, a metal porous body used as a current collector in which pores were filled with the negative electrode mixture and having a specific surface area of 200 m²/m³. The negative electrode of the coin type cell of Comparative Example 2 is common to Examples 1 and 2 in that a metal porous body is used, but is different from Examples 1 and 2 in that a void layer as illustrated in FIG. 1 is not formed.

### Comparative Example 3

A coin type cell of Comparative Example 3 was prepared in a similar manner to Comparative Example 1 except that the basis weight of the negative electrode active material in the negative electrode mixture layer was set to 10 mg/cm².

### Comparative Example 4

A coin type cell of Comparative Example 4 was prepared in a similar manner to Comparative Example 2 except that the basis weight of the negative electrode active material in the negative electrode mixture layer was set to 10 mg/cm².

### [Evaluation of Coin Type Cell]

Using the obtained coin type cells, a charge and discharge test was performed at a 0.05 C rate and a cutoff potential of 1.2 V to 0 V under a temperature condition of 60° C. The above operation was performed at each C rate of 1.0 C, 2.0 C, and 3.0 C, and a capacity when charging and discharging were performed was measured for each cycle.

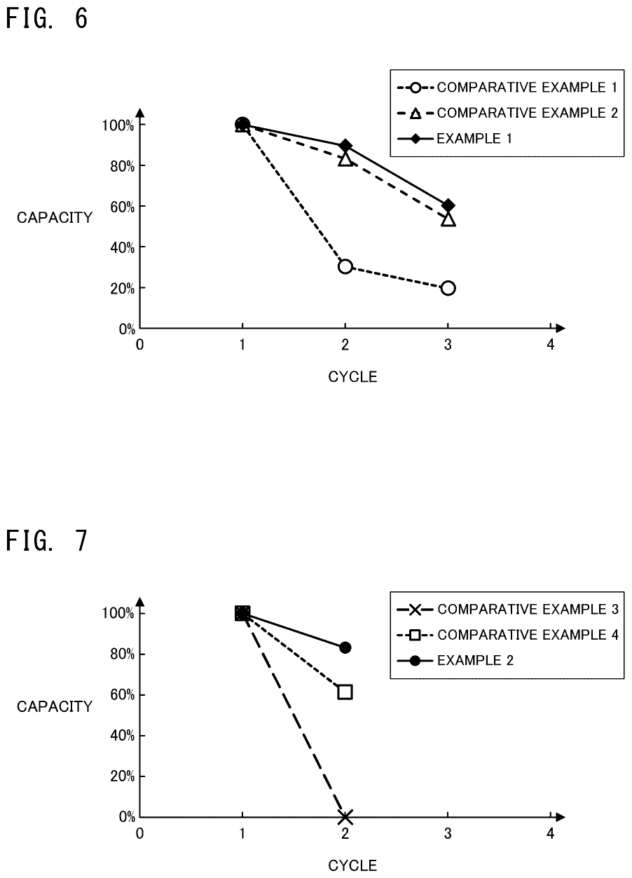

FIG. 6 is a diagram illustrating a capacity of a coin type cell for each cycle in each of Example 1 and Comparative Examples 1 and 2. The capacity illustrated in FIG. 6 is a ratio of a capacity of a coin type cell after charging and discharging to a capacity of the coin type cell before charging and discharging.

In Example 1, as compared with Comparative Examples 1 and 2, it was confirmed that the capacity tended to be less likely to decrease even when cycles were repeated, and a high capacity was maintained even when cycles were repeated. From the above results, it is found that a solid state battery including a negative electrode including a void layer including a portion containing a solid electrolyte and a portion having voids in pores of a metal porous body suppresses internal short circuit and the like due to deposition of metallic lithium, and brings about a result excellent in durability (cycle characteristics).

FIG. 7 is a diagram illustrating a capacity of a coin type cell for each cycle in each of Example 2 and Comparative Examples 3 and 4. The capacity illustrated in FIG. 7 is a ratio of a capacity of a coin type cell after charging and discharging to a capacity of the coin type cell before charging and discharging.

In Example 2, as compared with Comparative Examples 3 and 4, it was confirmed that the capacity tended to be less likely to decrease even when cycles were repeated, and a high capacity was maintained even when cycles were repeated. In particular, in a case where the basis weight of the negative electrode active material in the negative electrode mixture layer is 10 mg/cm², the capacity tends to decrease when cycles are repeated as compared with a case where the basis weight of the negative electrode active material in the negative electrode mixture layer is 5 mg/cm², but it is found that the solid state battery including the negative electrode including the void layer as in Example 2 brings about a result excellent in durability (cycle characteristics).

From the above results, it has been found that the present invention can provide a negative electrode in which an influence of deposition of metallic lithium or the like, such as internal short circuit, is less likely to occur when the negative electrode is used in a solid state battery.

What is claimed is:

1. A negative electrode of a solid state battery, the negative electrode comprising:
a negative electrode mixture layer formed by filling pores of a metal porous body with a negative electrode mixture containing a negative electrode active material; and
a void layer including a portion containing a solid electrolyte and a portion having voids in the pores of the metal porous body on a solid electrolyte layer side in a thickness direction of the metal porous body pressurized in the thickness direction, wherein
a specific surface area of the metal porous body before the pressurization is 500 m²/m³ or more and 6000 m²/m³ or less.

2. The negative electrode according to claim 1, wherein in the void layer, the solid electrolyte has a density of 1.5 g/cc or more and less than 1.8 g/cc.

3. The negative electrode according to claim 1, wherein in the void layer, a ratio of a volume occupied by the voids in the pores to a volume in the pores of the metal porous body is 10% or less.

4. The negative electrode according to claim 1, wherein the negative electrode active material contains at least a silicon-based material.

5. The negative electrode according to claim 4, wherein the negative electrode active material in the negative electrode mixture layer has a basis weight of more than 3 mg/cm².

6. The negative electrode according to claim 4, wherein a ratio of a discharge capacity of lithium that can enter the voids of the void layer due to charging and discharging to a discharge capacity of the negative electrode active material is 5% or more and 8% or less.

7. A solid state battery comprising: the negative electrode according to claim 1; a positive electrode containing lithium; and a solid electrolyte layer.

8. A manufacturing method of a laminate including a solid electrolyte layer and a negative electrode, the method comprising:
applying a negative electrode mixture containing a negative electrode active material to a metal porous body to form a negative electrode mixture layer in which pores of the metal porous body are filled with the negative electrode mixture;
pressing an uneven portion of a pressurizing device against a surface of the metal porous body in which the negative electrode mixture layer is formed to form an uneven portion on the surface; and
applying a solid electrolyte to a surface of the metal porous body on which the uneven portion is formed to form a void layer having a portion containing the solid electrolyte and a portion having voids in the pores of the metal porous body, and the solid electrolyte layer.
